(19) United States
(12) Patent Application Publication
(10) Pub. No.: US 2025/0192264 A1
(43) Pub. Date: Jun. 12, 2025

(54) MULTI-FUNCTION BARRIER TRAYS FOR USE WITHIN TRACTION BATTERY PACKS

(71) Applicant: FORD GLOBAL TECHNOLOGIES, LLC, Dearborn, MI (US)

(72) Inventors: Karen Siler, Commerce Township, MI (US); Joseph Fricano, Canton, MI (US); Jason C. Marcath, Dearborn, MI (US)

(21) Appl. No.: 18/813,400

(22) Filed: Aug. 23, 2024

Related U.S. Application Data
(60) Provisional application No. 63/607,888, filed on Dec. 8, 2023.

(51) Int. Cl. H01M 10/625; H01M 10/653; H01M 10/6554; H01M 50/249

(52) U.S. Cl. CPC H01M 10/625; H01M 10/653; H01M 10/6554; H01M 50/249; H01M 2220/20

(57) ABSTRACT

Multi-functional barrier trays are provided for use within traction battery packs. An exemplary barrier tray may be arranged between a heat exchanger plate and a cell stack of the traction battery pack for maintaining electrical isolation between battery cells of the cell stack and the heat exchanger plate, providing flat surfaces for cell stack thermal barrier and end plate components to interface relative to, and sealing interfaces between the cell stack and the heat exchanger plate.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to multi-function barrier trays for use within traction battery packs.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a battery cell stack, a heat exchanger plate, and a barrier tray positioned between the battery cell stack and the heat exchanger plate. The barrier tray includes an outer frame and a plurality of legs that together establish a ladder frame-like configuration.

In a further non-limiting embodiment of the foregoing traction battery pack, the outer frame of the barrier tray includes opposing longitudinal sections and transverse sections that connect between the opposing longitudinal sections.

In a further non-limiting embodiment of either of the foregoing traction battery packs, the plurality of legs extend between the opposing longitudinal sections.

In a further non-limiting embodiment of any of the foregoing traction battery packs, the barrier tray includes a pocket that is configured to receive a fin of a battery cell of the battery cell stack.

In a further non-limiting embodiment of any of the foregoing traction battery packs, the pocket establishes a barrier between the fin and the heat exchanger plate for providing electrical isolation.

In a further non-limiting embodiment of any of the foregoing traction battery packs, the barrier tray includes a first flat surface that is configured to interface with a thermal barrier assembly of the battery cell stack.

In a further non-limiting embodiment of any of the foregoing traction battery packs, the barrier tray includes a second flat surface that is configured to interface with an end plate of the battery cell stack.

In a further non-limiting embodiment of any of the foregoing traction battery packs, the barrier tray includes a pocket that is configured to receive a fin of a battery cell of the battery cell stack.

In a further non-limiting embodiment of any of the foregoing traction battery packs, the first flat surface extends within a plane that is vertically above a floor of the pocket.

In a further non-limiting embodiment of any of the foregoing traction battery packs, the barrier tray includes a flat surface that is configured to interface with an end plate of the battery cell stack.

In a further non-limiting embodiment of any of the foregoing traction battery packs, an adhesive secures the barrier tray to the heat exchanger plate.

In a further non-limiting embodiment of any of the foregoing traction battery packs, the outer frame of the barrier tray circumscribes a raised surface of the heat exchanger plate.

In a further non-limiting embodiment of any of the foregoing traction battery packs, the barrier tray includes an outboard ledge that is configured to interface with a cross-member assembly of the battery cell stack.

In a further non-limiting embodiment of any of the foregoing traction battery packs, the barrier tray includes a window that is configured interface with a compartment of battery cells of the battery cell stack.

In a further non-limiting embodiment of any of the foregoing traction battery packs, the barrier tray includes a cut-out section that is configured to be received around an electronic component of the traction battery pack.

A traction battery pack according to another exemplary aspect of the present disclosure includes, among other things, a battery cell stack, a heat exchanger plate including a raised surface, and a barrier tray positioned between the battery cell stack and the heat exchanger plate. The barrier tray includes an outer frame that circumscribes the raised surface and a plurality of legs that extend between opposing longitudinal sections of the outer frame.

In a further non-limiting embodiment of the foregoing traction battery pack, the barrier tray includes a pocket that is configured to receive a fin of a battery cell of the battery cell stack.

In a further non-limiting embodiment of either of the foregoing traction battery packs, the barrier tray includes a flat surface that is configured to interface with a thermal barrier assembly of the battery cell stack.

In a further non-limiting embodiment of any of the foregoing traction battery packs, the barrier tray includes a flat surface that is configured to interface with an end plate of the battery cell stack.

In a further non-limiting embodiment of any of the foregoing traction battery packs, the barrier tray includes an outboard ledge that is configured to interface with a cross-member assembly of the battery cell stack.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is an exploded view illustrating select portions of the traction battery pack of FIG. 2.

FIG. 4 illustrates an exemplary barrier tray that can be positioned between a cell stack and a heat exchanger plate of a traction battery pack.

FIG. 5 illustrates an exemplary interface between a barrier tray and each of battery cells, a thermal barrier, and an end plate of a cell stack.

FIG. 6 illustrates an exemplary interface between a barrier tray and a cross-member assembly of a cell stack.

FIG. 7 illustrates another exemplary barrier tray for use within a traction battery pack.

### DETAILED DESCRIPTION

This disclosure details multi-functional barrier trays for use within traction battery packs. An exemplary barrier tray may be arranged between a heat exchanger plate and a cell stack of the traction battery pack for maintaining electrical isolation between battery cells of the cell stack and the heat exchanger plate, providing flat surfaces for cell stack barrier and end plate components to interface relative to, and sealing interfaces between the cell stack and the heat exchanger plate. These and other features are discussed in greater detail in the following paragraphs of this detailed description.

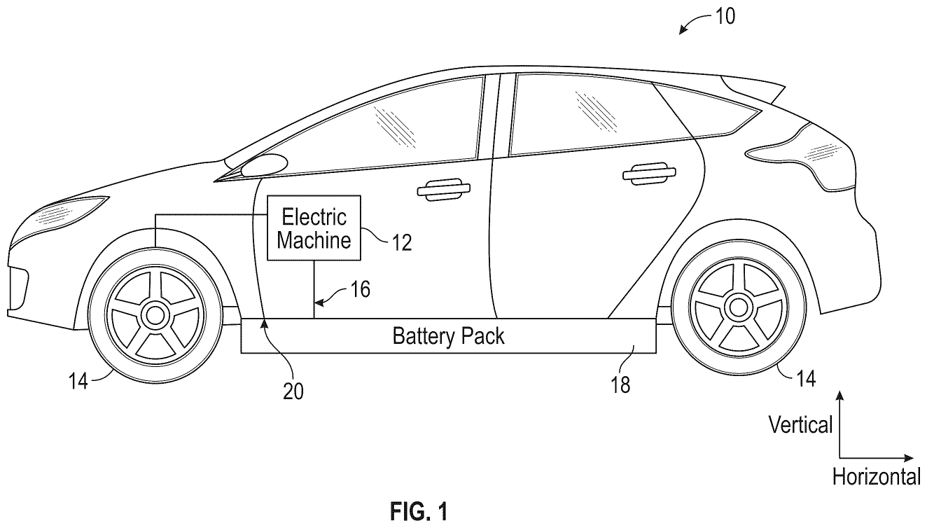

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

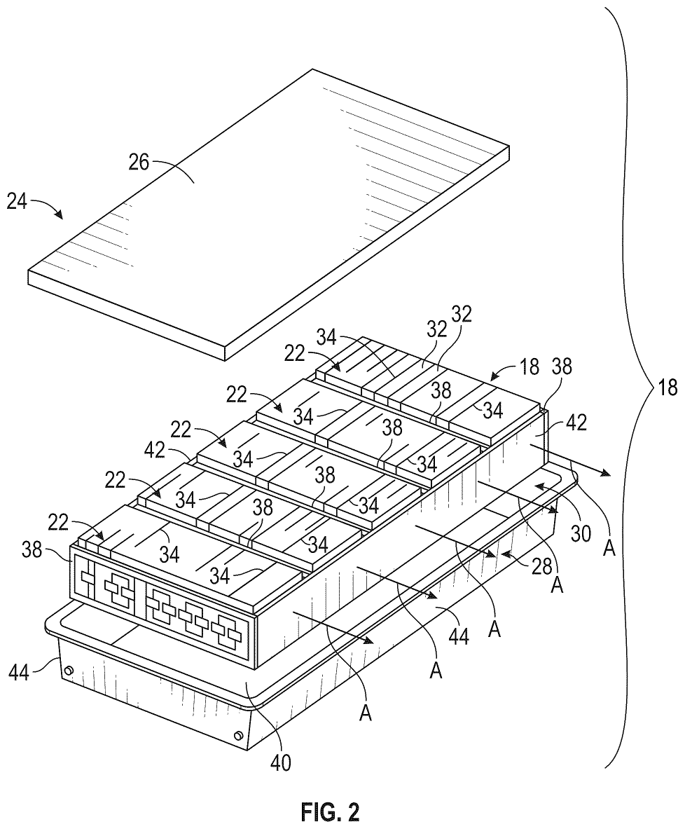

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 including any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The battery cells 32 can each include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

One or more thermal barrier assemblies 34 may be arranged along the respective cell stack axis A of each cell stack 22. The thermal barrier assemblies 34 may compartmentalize each cell stack 22 into two or more groupings or compartments.

The battery cells 32 and the thermal barrier assemblies 34 of each cell stack 22 may be arranged to extend between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and/or to the heat exchanger plate 40 by an adhesive 99 (see FIG. 6) to seal the interfaces between these neighboring components and to structurally integrate the traction battery pack 18.

The traction battery pack 18 may additionally include a pair of structural plate members 42. One structural plate member 42 may be positioned between ends of the cell stacks 22 and each longitudinally extending side wall 44 of the enclosure tray 28, for example. The structural plate members 42 may extend along axes that are substantially transverse (e.g. perpendicular) to the cell stack axes A of the cell stacks 22 and to the cross-member assemblies 38. The structural plate members 42 can span across a majority of the length of the longitudinally extending side walls 44 of the enclosure tray 28 and are thus sometimes referred to as structural “megabars” of the traction battery pack 18. However, other configurations are contemplated within the scope of this disclosure.

In an embodiment, the cell stacks 22 and their respective cross-member assemblies 38 extend longitudinally in a cross-vehicle direction of the electrified vehicle 10, and the structural plate members 42 extend longitudinally in a length-wise direction of the electrified vehicle 10. However, other configurations are contemplated within the scope of this disclosure.

The structural plate members 42 may be secured to the cell stacks 22 for further structurally integrating the traction battery pack 18. For example, a plurality of fasteners (e.g., bolts or screws, not shown in FIG. 2) may be inserted through the structural plate members 42 and can be accommodated within fastener openings of the cross-member assemblies 38 for securing the structural plate members 42 to the cell stacks 22. These connections can help contain tensile loads that can occur over the life of the cell stacks 22 as a result of battery cell expansion forces, for example.

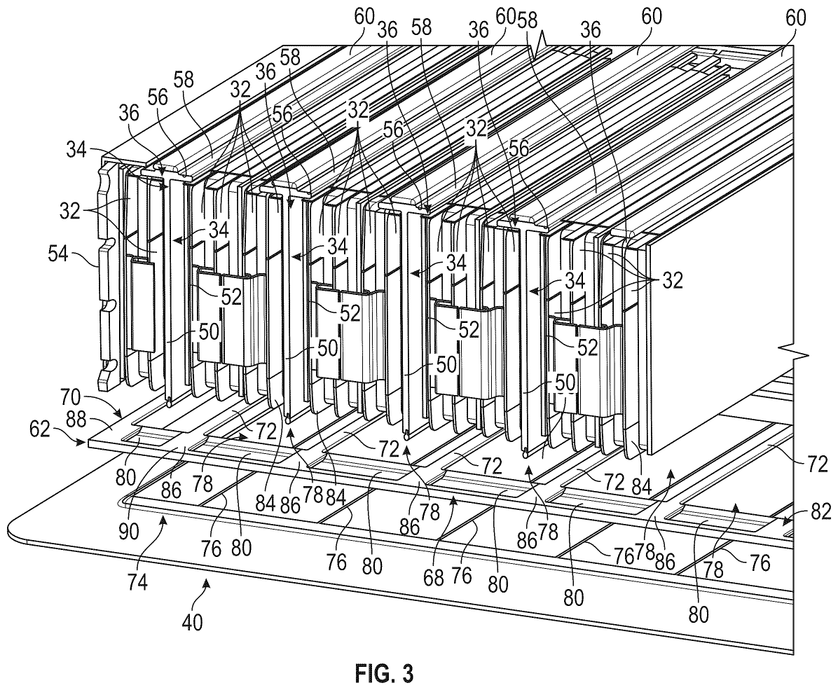

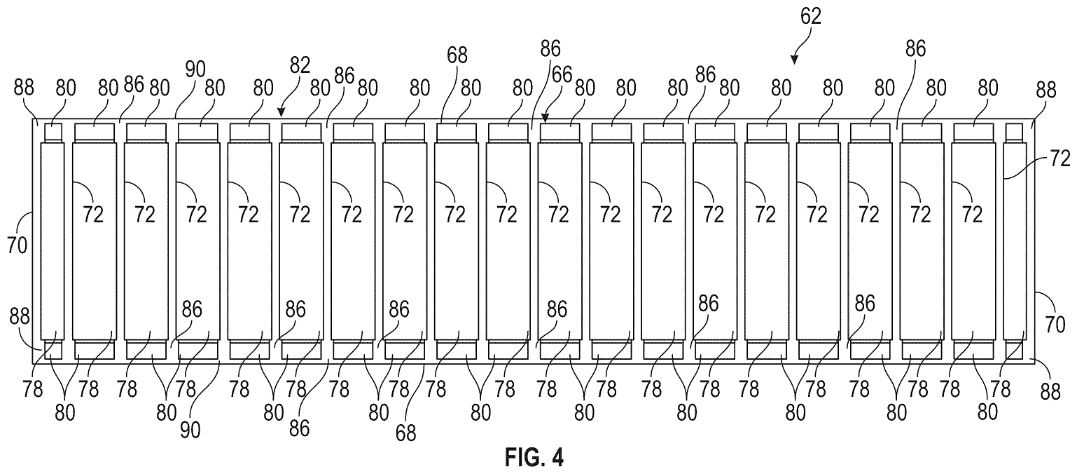

Referring now to FIGS. 3, 4, 5, and 6, with continued reference to FIGS. 1-2, one or more thermal barrier assemblies 34 may be arranged along the respective cell stack axis A of each cell stack 22. The thermal barrier assemblies 34 may compartmentalize each cell stack 22 into two or more subgroupings or compartments 36 of battery cells 32. Each compartment 36 may hold one or more of the battery cells 32 of the cell stack 22.

Should, for example, a battery thermal event occur in one of the cell stacks 22, the thermal barrier assemblies 34 may reduce or even prevent thermal energy associated with the thermal event from moving from cell-to-cell, compartment-to-compartment, and/or cell stack-to-cell stack, thereby inhibiting the transfer of thermal energy inside the traction battery pack 18.

Each thermal barrier assembly 34 of the cell stack 22 may include a structural barrier 50 that is flanked by pairs of thermal resistance material layers 52 as part of a multi-layered structure of the thermal barrier assembly 34. The structural barrier 50 may be sandwiched between the thermal resistance material layers 52. The thermal resistance material layers 52 can be positioned in abutting contact with major side surfaces of battery cells 32 located in adjacent compartments 36 of the cell stack 22.

The structural barrier 50 may include a thermoplastic structure or a polymer composite structure (e.g., glass fiber reinforced polypropylene with an intumescent additive), for example, and the thermal resistance material layers 52 may include aerogel layers or mica sheets, for example. However, other materials or combinations of materials could be utilized to construct the subcomponents of the thermal barrier assembly 34 within the scope of this disclosure.

The structural barrier 50 of the thermal barrier assembly 34 may be a pultrusion, which implicates structure to this component. A person of ordinary skill in the art having the benefit of this disclosure would understand how to structurally distinguish a pultruded structure from another type of structure, such as an extrusion, for example. The structural barrier 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the structural barrier 50. In other implementations, the structural barrier 50 could be an injection molded part or an extruded part.

Each thermal barrier assembly 34 may be configured to establish a sealed interface at the enclosure cover 26. For example, the structural barrier 50 of the thermal barrier assembly 34 may include an upper interfacing structure 56 that provides an upper plateau 58 for securing the thermal barrier assembly 34 to the enclosure cover 26, such as via an adhesive 60 (best shown in FIG. 3), for example. The adhesive 60 may be an epoxy based adhesive or a urethane based adhesive, for example. Once the upper interfacing structures 56 are secured relative to the enclosure cover 26, the thermal barrier assemblies 34 can substantially prevent thermal energy from moving from one compartment 36 to another at the sealed interface between each thermal barrier assembly 34 and the enclosure cover 26, such as during a battery thermal event, for example.

A barrier tray 62 may be arranged axially between the heat exchanger plate 40 and each cell stack 22 of the traction battery pack 18. As further discussed below, the barrier tray 62 is a multi-functional component that is configured to maintain electrical isolation between the battery cells 32 of the cell stack 22 and the heat exchanger plate 40, provide relatively level/flat surfaces for the thermal barrier assemblies 34 and end plates 54 of the cell stack 22 to interface relative to, seal interfaces between the cell stack 22 and the heat exchanger plate 40, etc.

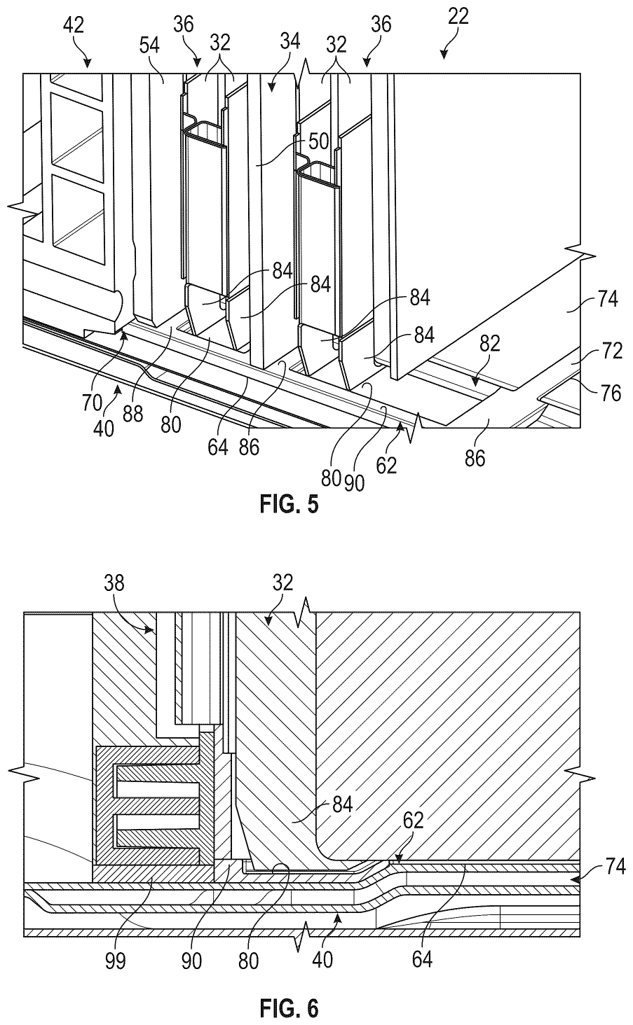

The barrier tray 62 may be positioned over top of the heat exchanger plate 40. In an embodiment, the barrier tray 62 is secured to the heat exchanger plate 40 by an adhesive 64 (see FIGS. 5-6).

In an embodiment, the barrier tray 62 is constructed from a plastic material that is capable of providing electrical isolation between the battery cells 32 and the heat exchanger plate 40. Other electrically isolating materials could be utilized within the scope of this disclosure.

The barrier tray 62 may include an outer frame 66 having a pair of longitudinal sections 68 and a pair of transverse sections 70 that connect between the longitudinal sections 68 at opposing ends of the outer frame 66. When the barrier tray 62 is arranged over the heat exchanger plate 40, the outer frame 66 may circumscribe a raised surface 74 of the heat exchanger plate 40. The barrier tray 62 can therefore accommodate for height variations of the heat exchanger plate 40 in order to provide level surfaces for various subcomponents of the cell stack 22 to be seated upon.

The barrier tray 62 may additionally include a plurality of legs 72 that laterally connect between the longitudinal sections 68. Together, the outer frame 66 and the legs 72 may establish a ladder frame-like configuration of the barrier tray 62.

Each leg 72 of the barrier tray 62 may be at least partially received within a slot 76 (see FIGS. 3 and 5) formed in the raised surface 74 of the heat exchanger plate 40. Each slot 76 may establish a thermal break within the heat exchanger plate 40. The legs 72 may seal the slots 76 for preventing thermal energy from moving from one compartment 36 of the cell stack 22 to another and for isolating the compartments 36 from one another to provide cell vent management during battery thermal events.

A window 78 extends between adjacent legs 72 of the barrier tray 62 and between legs 72 and the transverse section 70. The total number of legs 72 and windows 78 provided in the barrier tray 62 could vary and is therefore not intended to limit this disclosure.

Each window 78 may be sized to interface with one compartment 36 of battery cells 32 of the cell stack 22. The windows 78 allow for heat exchange to occur between the battery cells 32 and the heat exchanger plate 40 when the cell stack 22 is positioned over the barrier tray 62.

In some embodiments, at least one window 78 is sized differently from the remaining windows 78 of the barrier tray 62. For example, the windows 78 located between the transverse sections 70 and the outboard most legs 72 may be smaller in width than those extending between adjacent legs 72.

A plurality of pockets 80 may be formed in a top surface 82 of each longitudinal section 68 of the outer frame 66 of the barrier tray 62. Each pocket 80 may accommodate one or more fins 84 of the battery cells 32 of the cell stack 22 (see, e.g., FIGS. 3, 5, and 6). The fins 84 may have a greater vertical (i.e., Z-axis) dimension compared to a main body of each battery cell 32. The pockets 80 establish barriers for preventing the fins 84 from contacting the heat exchanger plate 40, thereby providing electrical isolation.

A flat section 86 of the top surface 82 may extend between adjacent pockets 80 of the barrier tray 62. Each leg 72 may extend between axially aligned flat sections 86 of the outer frame 66. The flat sections 86 may extend within a plane that is vertically higher than a floor of each pocket 80. Each flat section 86 may provide a relatively level or flat receiving surface for locating and seating one of the thermal barrier assemblies 34 relative to the barrier tray 62 (see, e.g., FIGS. 3 and 5). By virtue of the flat sections 86, the barrier tray 62 can accommodate for height variations of the heat exchanger plate 40 and eliminate the need to provide a specialized contour at the lower portion of each structural barrier 50.

Each transverse section 70 of the outer frame 66 may provide additional flat sections 88. The flat sections 88 may provide relatively level or flat receiving surfaces for locating and seating the end plates 54 relative to the barrier tray 62 (see, e.g., FIGS. 3 and 5). By virtue of the flat sections 88, the barrier tray 62 can accommodate for height variations of the heat exchanger plate 40 and eliminate the need to provide a specialized contour at the lower portion of each end plate 54.

An outboard ledge 90 of the top surface 82 of each longitudinal section 68 may provide relatively level or flat receiving surfaces for locating and seating the cross-member assemblies 38 relative to the barrier tray 62 (see, e.g., FIG. 6). The outboard ledge 90 may extend in the same plane as the flat sections 86 and the flat sections 88.

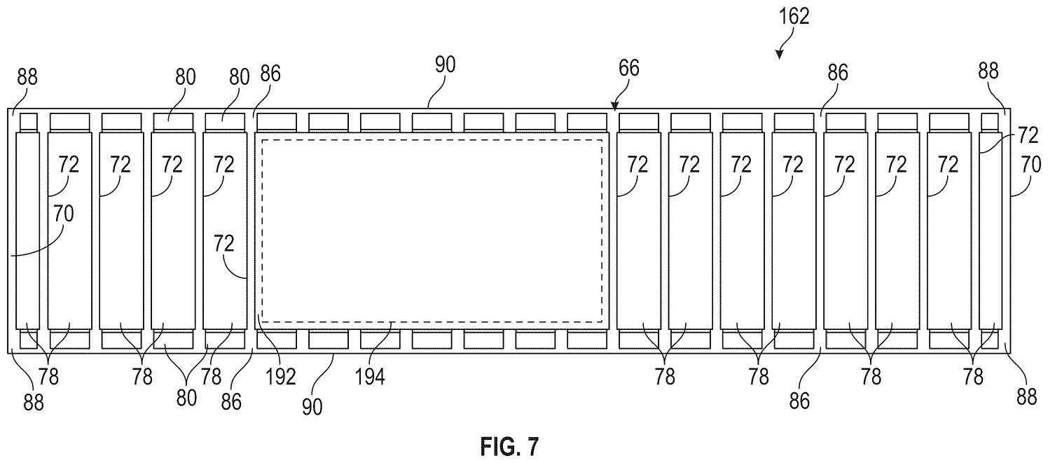

FIG. 7 illustrates another exemplary barrier tray 162 that could be disposed between one or more cell stacks 22 and the heat exchanger plate 40 of the traction battery pack 18. The barrier tray 162 is similar to the barrier tray 62 of FIGS. 3-6 and thus includes both the outer frame 66 and the legs 72 that provide the ladder frame-like configuration. However, in this embodiment, the barrier tray 162 may include a cut-out section 192. The cut-out section 192 may be an opening of the barrier tray 162 that is larger than the windows 78.

The cut-out section 192 may be sized to be received around an electronic component 194 (shown schematically using dashed lines for simplicity) of the traction battery pack 18. The electronic component 194 could be a bussed electrical center (BEC) or a battery electric control module (BECM), for example.

The exemplary traction battery packs of this disclosure include multi-function barrier trays arranged to establish an intermediate barrier between a cell stack and a heat exchanger plate. Among other functions, the barrier trays may be configured to maintain electrical isolation between battery cells of the cell stack and the heat exchanger plate, provide level/flat surfaces for cell stack barrier and end plate components to interface with, and seal interfaces between the cell stack and the heat exchanger plate.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery cell stack;
a heat exchanger plate; and
a barrier tray positioned between the battery cell stack and the heat exchanger plate and including an outer frame and a plurality of legs that together establish a ladder frame-like configuration of the barrier tray.

2. The traction battery pack as recited in claim 1, wherein the outer frame of the barrier tray includes opposing longitudinal sections and transverse sections that connect between the opposing longitudinal sections.

3. The traction battery pack as recited in claim 2, wherein the plurality of legs extend between the opposing longitudinal sections.

4. The traction battery pack as recited in claim 1, wherein the barrier tray includes a pocket that is configured to receive a fin of a battery cell of the battery cell stack.

5. The traction battery pack as recited in claim 4, wherein the pocket establishes a barrier between the fin and the heat exchanger plate for providing electrical isolation.

6. The traction battery pack as recited in claim 1, wherein the barrier tray includes a first flat surface that is configured to interface with a thermal barrier assembly of the battery cell stack.

7. The traction battery pack as recited in claim 6, wherein the barrier tray includes a second flat surface that is configured to interface with an end plate of the battery cell stack.

8. The traction battery pack as recited in claim 6, wherein the barrier tray includes a pocket that is configured to receive a fin of a battery cell of the battery cell stack.

9. The traction battery pack as recited in claim 8, wherein the first flat surface extends within a plane that is vertically above a floor of the pocket.

10. The traction battery pack as recited in claim 1, wherein the barrier tray includes a flat surface that is configured to interface with an end plate of the battery cell stack.

11. The traction battery pack as recited in claim 1, comprising an adhesive that secures the barrier tray to the heat exchanger plate.

12. The traction battery pack as recited in claim 1, wherein the outer frame of the barrier tray circumscribes a raised surface of the heat exchanger plate.

13. The traction battery pack as recited in claim 1, wherein the barrier tray includes an outboard ledge that is configured to interface with a cross-member assembly of the battery cell stack.

14. The traction battery pack as recited in claim 1, wherein the barrier tray includes a window that is configured interface with a compartment of battery cells of the battery cell stack.

15. The traction battery pack as recited in claim 14, wherein the barrier tray includes a cut-out section that is configured to be received around an electronic component of the traction battery pack.

16. A traction battery pack, comprising:
a battery cell stack;
a heat exchanger plate including a raised surface; and
a barrier tray positioned between the battery cell stack and the heat exchanger plate,
wherein the barrier tray includes an outer frame that circumscribes the raised surface and a plurality of legs that extend between opposing longitudinal sections of the outer frame.

17. The traction battery pack as recited in claim 16, wherein the barrier tray includes a pocket that is configured to receive a fin of a battery cell of the battery cell stack.

18. The traction battery pack as recited in claim 16, wherein the barrier tray includes a flat surface that is configured to interface with a thermal barrier assembly of the battery cell stack.

19. The traction battery pack as recited in claim 16, wherein the barrier tray includes a flat surface that is configured to interface with an end plate of the battery cell stack.

20. The traction battery pack as recited in claim 16, wherein the barrier tray includes an outboard ledge that is configured to interface with a cross-member assembly of the battery cell stack.
